(19) United States
(12) Patent Application Publication
(10) Pub. No.: US 2007/0216672 A1
(43) Pub. Date: Sep. 20, 2007

(54) Power driving system and liquid crystal display using same

(75) Inventors: Kun-Hsien Yang, Miao-Li (TW); Chien-Fan Tung, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/725,744

(22) Filed: Mar. 19, 2007

(30) Foreign Application Priority Data
Mar. 17, 2006 (TW) 95109285

(51) Int. Cl. G09G 5/00

(52) U.S. Cl. 345/211

(57) ABSTRACT

An exemplary power driving system (21) typically used in a liquid crystal display (LCD), including a power supply circuit (22), the power supply circuit (22) includes a flyback circuit (224) configured for transforming a high alternating current (AC) voltage to a plurality of low DC voltages and providing a plurality of low direct current (DC) voltages to a gate driver (283) and a data driver (282) of the LCD.

### FIELD OF THE INVENTION

The present invention relates to an electrical power driving system and a liquid crystal display (LCD) using the power driving system.

### GENERAL BACKGROUND

An LCD has the advantages of portability, low power consumption, and low radiation, and has been widely used in various portable information products such as notebooks, personal digital assistants (PDAs), video cameras, and the like. Furthermore, the LCD is considered by many to have the potential to completely replace CRT (cathode ray tube) monitors and televisions.

FIG. 2 is a block diagram of a typical LCD. The LCD 10 includes an LCD module 18, a smart panel 16, a power driving system 11, and a backlight 19. The power driving system 11 provides operation voltages for the LCD 10. The smart panel 16 is used to control a driving circuit of the LCD module 18.

The LCD module 18 includes a pixel array 181, a data driver 182, and a gate driver 183. The data driver 182 and the gate driver 183 are used to drive the pixel array 181. The gate driver 183 receives a gate-on voltage V_{GH} and a gate-off voltage V_{GL}, generates scanning signals, and provides the scanning signals to the pixel array 181. The gate-on voltage V_{GH} is approximately equal to plus fifteen volts or plus twenty-four volts. The gate-off voltage V_{GL} is approximately equal to minus ten volts or minus six volts. The data driver 182 receives a major driving voltage AVDD for generating gradation voltages, and provides the gradation voltages to the pixel array 181.

The smart panel 16 includes a scalar circuit 161 and a timing control circuit 162. The scalar circuit 161 includes two input terminals (not labeled) for respectively receiving a low voltage differential signal (LDVS)/transition minimized differential signal (TMDS), and a video signal, from an external circuit (not shown). The scalar circuit 161 generates a switch signal and a timing control signal according to the received LDVS/TMDS and video signal. The timing control circuit 162 is used to control the data driver 182 and the gate driver 183, so as to display images on the pixel array 181.

The power driving system 11 includes a power supply circuit 12 and a power controlling circuit 14. The power supply circuit 12 provides an operation voltage to the power controlling circuit 14 and the smart panel 16.

The power supply circuit 12 includes a rectifier 121, a direct current to direct current (DC-DC) converter 122, and an inverter 123. The rectifier 121 receives a high AC (alternating current) voltage that is approximately in the range from 110˜220 volts from an external power supply (not shown), and generates a high DC (direct current) voltage. The DC-DC converter 122 transforms the high DC voltage to a plus five volts DC voltage and a plus twelve volts DC voltage. The scalar circuit 161 receives the plus five volts DC voltage. The inverter 123 receives the plus twelve volts DC voltage, and generates a high AC backlight driving voltage for driving the backlight 19 of the LCD 10.

The power controlling circuit 14 includes a pulse width modulation (PWM) circuit 141, a step-down circuit 142, and a step-up circuit 143. The PWM circuit 141 receives the switch signal from the scalar circuit 161 through a conducting line (not labeled) positioned on the power controlling circuit 14. The switch signal is used to turn on or turn off the PWM circuit 141. The step-up circuit 143 and the PWM circuit 141 together generate the major driving voltage AVDD, and provide the major driving voltage AVDD to an input terminal “C” of the data driver 182. The step-up circuit 143 and the PWM circuit 141 together also generate the gate-on voltage V_{GH} and the gate-off voltage V_{GL}, and provide the voltages V_{GH}, V_{GL} to two input terminals “A”, “B” of the gate driver 183 respectively. The step-down circuit 142 receives the timing control signal generated by the scalar circuit 161, and controls the timing control circuit 162 according to the timing control signal.

The power driving system 11 of the LCD 10 includes the PWM circuit 141. The PWM circuit 141 together with the step-up circuit 143 generate the voltages AVDD, V_{GH}, V_{GL} according to the received switch signal generated by the scalar circuit 161, and provide the voltages AVDD, V_{GH}, V_{GL} to the LCD module 18. Typically, the cost of the PWM circuit 141 is high, thus increasing the cost of the power driving system 11 of the LCD 10.

It is desired to provide a power driving system and an LCD which overcome the above-described deficiencies.

### SUMMARY

In one preferred embodiment, a power driving system used in a liquid crystal display (LCD) includes a power supply circuit. The power supply circuit includes a flyback circuit which is configured for transforming a high alternating current (AC) voltage to a plurality of low direct current (DC) voltages and respectively providing a plurality of the low DC voltages to a gate driver and a data driver of the LCD.

Other novel features and advantages of the above-described power driving system will become more apparent from the following detailed description when taken in conjunction with the accompanying drawings.

### BRIEF DESCRIPTION OF THE DRAWINGS

FIG. 1 is a block diagram of an LCD according to one preferred embodiment of the present invention, the LCD including a power driving system.

FIG. 2 is a block diagram of a conventional LCD, the LCD including a power driving system.

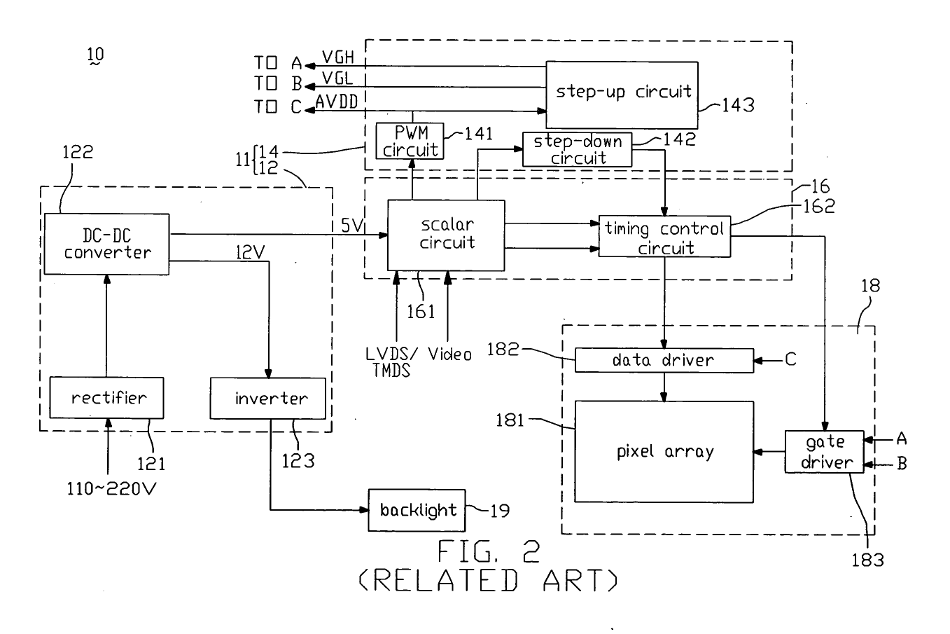

### DETAILED DESCRIPTION OF PREFERRED EMBODIMENTS

Reference will now be made to the drawings to describe the present invention in detail.

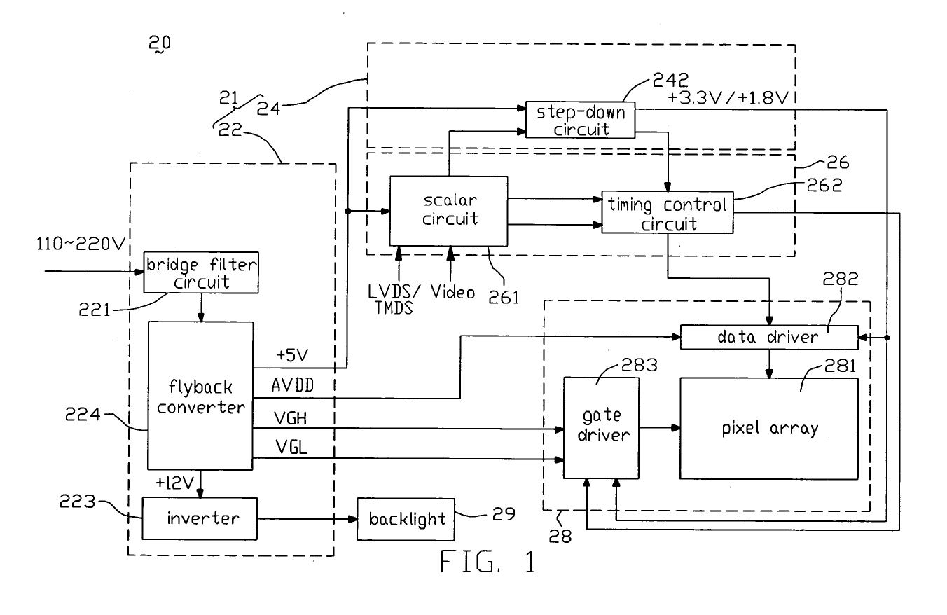

FIG. 1 is a block diagram of an LCD according to a preferred embodiment of the present invention. The LCD 20 includes an LCD module 28, a smart panel 26, a power driving system 21, and a backlight 29. The power driving system 21 provides operation voltages for the LCD 20. The smart panel 26 is used to control a driving circuit of the LCD module 28. The backlight 29 is typically one or more cold cathode fluorescent lamps (CCFLs).

The LCD module 28 includes a pixel array 281, a data driver 282, and a gate driver 283. The data driver 282 and the gate driver 283 are used to drive the pixel array 281. The gate driver 282 receives a gate-on voltage V_{GH} and a gate-off voltage V_{GL}, generates scanning signals, and provides the scanning signals to the pixel array 281. Typically, the gate-on voltage V_{GH} is approximately equal to plus fifteen volts or plus twenty-four volts. Typically, the gate-off voltage V_{GL} is approximately equal to minus ten volts or minus six volts. The data driver 282 receives a major operation voltage AVDD for generating a plurality of gradation voltages, and provides the gradation voltages to the pixel array 281. Typically, the major operation voltage AVDD is approximately equal to plus five volts or plus twelve volts.

The smart panel 26 includes a scalar circuit 261 and a timing control circuit 262. The scalar circuit 261 includes two input terminals (not labeled) for respectively receiving a low voltage differential signal (LDVS)/transition minimized differential signal (TMDS), and a video signal, from an external circuit (not shown). The scalar circuit 261 generates a timing control signal according to the received LDVS/TMDS and video signal. The timing control circuit 262 is used to control operation of the data driver 282 and the gate driver 283 so as to display images on the pixel array 281.

The power driving system 21 includes a power supply circuit 22 and a power controlling circuit 24. The power supply circuit 22 provides an operation voltage to the power controlling circuit 24 and the smart panel 26.

The power supply circuit 22 includes a bridge filter circuit 221, an inverter 223, and a flyback converter 224. The bridge filter circuit 221 receives a high AC voltage that is approximately in the range from 110˜220 volts from an external power supply (not shown), and generates a steady AC voltage which is approximately in the range from 110˜220 volts. The flyback converter 224 is a so-called “converter of single-ended flyback”, and functions as a step-up/step-down transformer. The flyback converter 224 typically includes inductances, capacitors, and other known electrical units. When the flyback converter 224 receives the steady high AC voltage generated by the bridge filter circuit 221, a plurality of low DC voltages can be generated and outputted according to the inductances of the flyback converter 224, with each inductance having a particular number of turns. The low DC voltages include a plus five volts DC voltage for driving the smart panel 26 and the power controlling circuit 24, a plus twelve volts DC voltage for driving the inverter 223, a major operation voltage AVDD for driving the data driver 282, and the gate-on voltage V_{GH} and the gate-off voltage V_{GL} both provided to the gate driver 283.

The inverter 123 receives the plus twelve volts DC voltage and generates a high AC backlight driving voltage for driving the backlight 29.

The power controlling circuit 24 includes a step-down transformer 242. In the illustrated embodiment, the step-down transformer 242 is a step-down circuit 242. The step-down circuit 242 receives the timing control signal generated by the scalar circuit 261 and the plus five volts DC voltage generated by the flyback converter 224, and generates a plus three point three volts (+3.3 V) DC voltage or a plus one point eight volts (+1.8 V) DC voltage. The +3.3 V or +1.8 V DC voltage is provided to both the data driver 282 and the gate driver 283 as their respective operation voltages.

The power supply circuit 22 of the LCD 20 includes the flyback converter 224, which is configured for outputting a plurality of various low DC voltages. From among these low DC voltages, some of them are provided directly to the data driver 282 and the gate driver 283 respectively; and another one of them is converted to a corresponding low DC voltage that is then provided to the data driver 282 and the gate driver 283 respectively. Thus, the data driver 282 and the gate driver 283 are provided with the necessary respective voltages needed to cooperatively help drive the pixel array 281 to display images. Because the flyback converter 224 is typically constituted of a plurality of low-cost electrical units such as inductances and capacitors, the cost of the power driving system 21 is reduced. Thus the cost of the LCD 20 can also be reduced.

It is to be understood, however, that even though numerous characteristics and advantages of preferred and exemplary embodiments have been set out in the foregoing description, together with details of the structures and functions of the embodiments, the disclosure is illustrative only; and that changes may be made in detail, especially in matters of shape, size, and arrangement of parts within the principles of present invention to the full extent indicated by the broad general meaning of the terms in which the appended claims are expressed.

What is claimed is:

1. A power driving system comprising a power supply circuit, the power supply circuit comprising a flyback circuit configured for transforming a high alternating current (AC) voltage to a plurality of low direct current (DC) voltages and respectively providing a plurality of the low DC voltages to a gate driver and a data driver of a liquid crystal display (LCD).

2. The power driving system as claimed in claim 1, wherein the flyback converter comprises a plurality of inductances and a plurality of capacitors.

3. The power driving system as claimed in claim 1, further comprising a power controlling circuit, the power controlling circuit comprising a step-down transformer configured for receiving one of said plurality of the low DC voltages and generating a 3.3 volts DC voltage or a 1.8 volts DC voltage and providing the 3.3 volts DC voltage or the 1.8 volts DC voltage to both the gate driver and the data driver of the LCD.

4. The power driving system as claimed in claim 1, wherein the power supply circuit further comprises a bridge filter circuit configured for receiving the high AC voltage from an external power supply and generating a corresponding steady AC voltage.

5. The power driving system as claimed in claim 4, wherein the high AC voltage is in the range from approximately 110 volts to approximately 220 volts, and the steady AC voltage is in the range from approximately 110 volts to approximately 220 volts.

6. The power driving system as claimed in claim 1, wherein the power supply circuit further comprises an inverter configured for receiving one of said plurality of low DC voltages and transforming the received low DC voltage to a high AC voltage in order to drive a backlight of the LCD.

7. A liquid crystal display (LCD) comprising:
an LCD module comprising a gate driver and a data driver;
a smart panel configured for controlling the LCD module to display images; and
a power supply circuit, the power supply circuit comprising a flyback circuit configured for transforming a high alternating current (AC) voltage to a plurality of low direct current (DC) voltages and respectively providing a plurality of the low DC voltages to the gate driver and the data driver of the LCD module.

8. The LCD as claimed in claim 7, wherein the flyback converter comprises a plurality of inductances and a plurality of capacitors.

9. The LCD as claimed in claim 7, wherein the LCD module further comprises a pixel array, and the gate driver is configured for providing scanning signals to the pixel array.

10. The LCD as claimed in claim 7, wherein the LCD module further comprises a pixel array, and the data driver is configured for providing a plurality of gradation voltages to the pixel array.

11. The LCD as claimed in claim 7, wherein the smart panel comprises:
a scalar circuit comprising two input terminals for respectively receiving a low voltage differential signal (LDVS) or a transition minimized differential signal (TMDS), and a video signal, from an external circuit; and
a timing control circuit configured for controlling the data driver and the gate driver.

12. The LCD as claimed in claim 7, wherein said plurality of the low DC voltages comprise a low positive DC voltage and a low negative DC voltage provided to the gate driver, and a low positive DC voltage provided to the data driver.

13. The LCD as claimed in claim 7, wherein the power supply circuit further comprises a bridge filter circuit configured for receiving the high AC voltage from an external power supply and generating a corresponding steady AC voltage.

14. The LCD as claimed in claim 13, wherein the high AC voltage is in the range from approximately 110 volts to approximately 220 volts, and the steady AC voltage is in the range from approximately 110 volts to approximately 220 volts.

15. The LCD as claimed in claim 7, further comprising a backlight.

16. The LCD as claimed in claim 15, wherein the power supply circuit further comprises an inverter configured for receiving one of said plurality of low DC voltages and transforming the received low DC voltage to a high AC voltage for driving the backlight of the LCD.

17. The LCD as claimed in claim 7, further comprising a power controlling circuit, the power controlling circuit comprising a step-down transformer configured for receiving one of said plurality of the low DC voltages and generating a 3.3 volts DC voltage or a 1.8 volts DC voltage and providing the 3.3 volts DC voltage or 1.8 volts DC voltage to both the gate driver and the data driver.

18. A liquid crystal display circuits arrangement comprising: a gate driver linked to a pixel array and linked by a step-down circuit, a time control circuit and a flyback converter which directly sends a gate-on voltage and a gate-off voltage to the gate drive so as to have the gate drive provide scanning signals to the pixel array.
